(19) United States
(12) Patent Application Publication
(10) Pub. No.: US 2014/0097777 A1
(43) Pub. Date: Apr. 10, 2014

(54) DRIVING A ROTATING DEVICE BASED ON A COMBINATION OF SPEED DETECTION BY A SENSOR AND SENSOR-LESS SPEED DETECTION

(71) Applicant: Marvell World Trade Ltd., St. Michael (BB)

(72) Inventors: Foo Leng Leong, Singapore (SG); Ravishanker Krishnamoorthy, Singapore (SG)

(73) Assignee: Marvell World Trade Ltd., St. Michael (BB)

(21) Appl. No.: 14/043,405

(22) Filed: Oct. 1, 2013

Related U.S. Application Data
(60) Provisional application No. 61/709,732, filed on Oct. 4, 2012.

(51) Int. Cl. H02P 7/06; H02P 1/04; G01P 3/44

(52) U.S. Cl. CPC H02P 7/06; G01P 3/44; H02P 1/04
USPC 318/430; 318/461

(57) ABSTRACT

Some of the embodiments of the present disclosure provide a method comprising detecting, based on a sensor and a back electromagnetic force generated in a rotating device, a speed of the rotating device; and based on (i) the speed detected using the sensor or (ii) the speed detected using the back electromagnetic force, driving the rotating device.

### CROSS REFERENCE TO RELATED APPLICATIONS

This claims priority to U.S. Provisional Patent Application No. 61/709,732, filed on Oct. 4, 2012, which is incorporated herein by reference.

### TECHNICAL FIELD

Embodiments of the present disclosure relate to rotating devices, and more particularly, to driving a rotating device based on detection of a speed of the rotating device.

### BACKGROUND

Unless otherwise indicated herein, the approaches described in this section are not prior art to the claims in the present disclosure and are not admitted to be prior art by inclusion in this section.

Sensors, e.g., Hall effect sensors, are often used in a motor to detect a position of the motor (e.g., detect a position of the rotor and/or the poles of the motor) and/or a speed of the motor. Such detection of the position and/or the speed is used, for example, to drive the motor (e.g., to control the speed of the motor, perform a soft start of the motor, etc.). For example, a three phase motor may need three or more sensors to relatively accurately rack the position and/or the speed of the motor.

In general, a relatively large number of Hall effect sensors increase an accuracy of detection of the position and/or speed of a motor. However, for example, if one or more of the Hall effect sensors fail, it may not be possible to relatively accurately detect the position and/or speed of the motor. Furthermore, a manufacturing cost increases with a large number of Hall effect sensors. Also, each Hall effect sensor included in a motor may have an associated integrated circuit (IC), thereby further increasing a cost of incorporating a large number of Hall effect sensors. Additionally, as more Hall effect sensors are disposed in a motor, a space necessary to accommodate the Hall effect sensors, the accompanying ICs and the wirings also increases, thereby increasing a complexity of the system. For example, it may be difficult to route the wires associated with the Hall effect sensors and the accompanying ICs, and multiple layers of a printed circuit board (PCB) may be needed for routing the wires and accommodating the ICs.

### SUMMARY

In various embodiments, the present disclosure provides a method comprising detecting, based on a sensor and a back electromagnetic force generated in a rotating device, a speed of the rotating device; and based on (i) the speed detected using the sensor or (ii) the speed detected using the back electromagnetic force, driving the rotating device. Detecting the speed of the rotating device further comprises during a start-up of the rotating device, detecting, based on the sensor, the speed of the rotating device; and subsequent to the start-up of the rotating device and while the speed of the rotating device is higher than a threshold speed, detecting the back electromagnetic force generated in the rotating device, and detecting, based on the detected back electromagnetic force generated in the rotating device, the speed of the rotating device. Detecting the speed of the rotating device further comprises: while the speed of the rotating device is lower than a threshold speed, detecting, based on the sensor, the speed of the rotating device; and while the speed of the rotating device is higher than the threshold speed, detecting the back electromagnetic force generated in the rotating device, and detecting, based on the detected back electromagnetic force generated in the rotating device, the speed of the rotating device. In an embodiment, the method further comprises while the speed of the rotating device is lower than the threshold speed, refraining from detecting the speed of the rotating device using the back electromagnetic force. Detecting the speed of the rotating device while the speed of the rotating device is higher than the threshold speed further comprises while the speed of the rotating device is higher than the threshold speed, detecting, using (i) the detected back electromagnetic force and (ii) the sensor, the speed of the rotating device. Driving the rotating device further comprises: based on the speed detected using the sensor, performing a soft start of the rotating device by regulating a voltage applied to the rotating device during a start-up of the rotating device. Driving the rotating device further comprises: based on the speed detected using the back electromagnetic force, driving the rotating device while the speed of the rotating device is higher than a threshold speed. In an embodiment, the method further comprises: while the speed of the rotating device is lower than a threshold speed, monitoring, using the sensor, a position of the rotating device, wherein monitoring the position of the rotating device comprises monitoring a position of at least one of a pole and a rotor of the rotating device; and while the speed of the rotating device is higher than the threshold speed, monitoring, using the detected back electromagnetic force, the position of the rotating device, wherein driving the rotating device further comprises based on (i) the position detected using the sensor or (ii) the position detected using the back electromagnetic force, driving the rotating device. The back electromagnetic force is generated in a winding of the rotating device, based on the rotation of the rotating device. In an embodiment, the method further comprises: detecting an absence of back electromagnetic force generated in the rotating device; and based on detecting the absence of back electromagnetic force generated in the rotating device, detecting a rotor lock event in the rotating device. The sensor comprises one or more Hall effect sensors.

In various embodiments, the present disclosure provides a system comprising: a rotating device; a sensor configured to detect the speed of the rotating device; and a back electromagnetic force (BEMF) module configured to detect a back electromagnetic force generated in the rotating device, and detect, using the detected back electromagnetic force, the speed of the rotating device, wherein the rotating device is driven based on the speed detected using (i) the output of the sensor or (ii) the speed detected using the back electromagnetic force.

### BRIEF DESCRIPTION OF THE DRAWINGS

In the following detailed description, reference is made to the accompanying drawings which form a part hereof wherein like numerals designate like parts throughout, and in which is shown by way of embodiments that illustrate principles of the present disclosure. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

FIG. 1 schematically illustrates a system for detecting a position and/or a speed of a motor, and driving the motor.

FIG. 2 illustrates an example method for detecting a position and/or a speed of a rotating device, and driving the rotating device.

### DETAILED DESCRIPTION

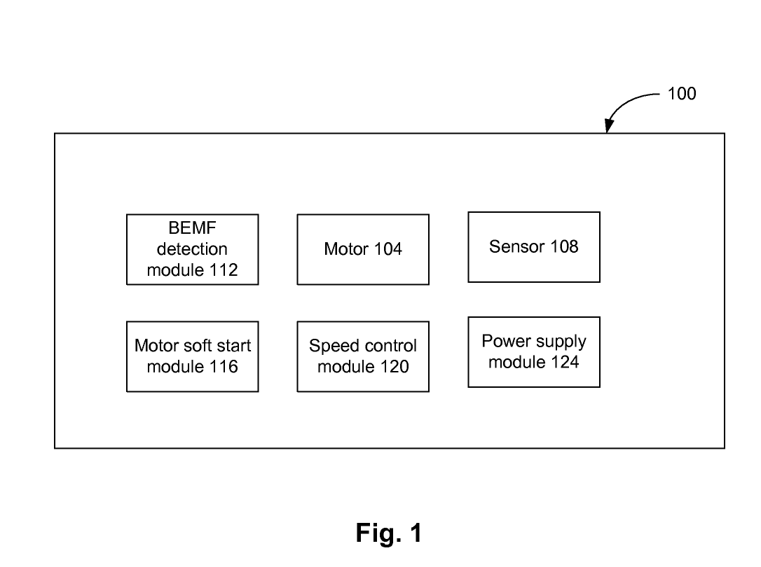

FIG. 1 schematically illustrates a system 100 for detecting a position of a motor 104 (e.g., detecting a position of a rotor and/or the poles of the motor 104) and/or a speed of the motor 104, and driving the motor 104. The motor 104 may be used for any appropriate purposes, e.g., to rotate a fan, rotate a disk drive of a disk drive system, rotate any appropriate rotating component, and/or the like.

In an embodiment, the system 100 comprises a motor soft start module 116 configured to start the motor 104 (e.g., to perform a soft start of the motor 104), a speed control module 120 configured to regulate a speed of the motor 104, and a power supply module 124 configured to supply power to one or more components of the system 100 (e.g., supply power for rotation of the motor 104). The power supplied to the motor 104 is, for example, one of a single phase alternating current (AC), a two phase AC, a three phase AC, a direct current (DC), or the like. In an embodiment, the motor soft start module 116 and the speed control module 120 can be, for example, integrated in a single module that is configured to (i) perform a soft start of the motor 104 and (ii) regulate the speed of the motor 104 subsequent to the soft start of the motor 104.

In an embodiment, the system 100 includes a sensor 108. An output of the sensor 108, for example, can be used to detect a position of the motor 104 (e.g., a position of a pole and/or a rotor of the motor 104) while the motor 104 is being rotated. Additionally or alternatively, the output of the sensor 108 can be used to detect a speed of the motor 104. Thus, the sensor 108 acts as a position sensor, a speed sensor, or a combination of a position sensor and a speed sensor. Although only one sensor 108 is illustrated in FIG. 1, the sensor 108, in an embodiment, represents one or more sensors.

As is well known to those skilled in the art, a Hall effect sensor is a transducer having an output that varies in response to a variation of a magnetic field passing through the Hall effect sensor. In an embodiment, the sensor 108 comprises a Hall effect sensor disposed near a periphery of a path of rotation of the rotor of the motor 104. While the motor 104 rotates, the poles of the motor periodically pass near the Hall effect sensor, wherein a periodicity of the pole passing near the Hall effect sensor is based on the speed of the motor 104. Each time a pole of the motor 104 passes near the Hall effect sensor while the motor 104 rotates, an output voltage of the Hall effect sensor changes (e.g., due to a variation in the magnetic field passing through the Hall effect sensor because of the passing pole). Such a change in the output voltage of the Hall effect sensor indicates a passage of the pole of the motor 104 near the Hall effect sensor. A circuit (not illustrated in FIG. 1) associated with the Hall effect sensor detects such a change in the output voltage of the Hall effect sensor, thereby detecting a current position of the pole of the motor 104. A speed of the motor 104 can also be determined based on the output of the Hall effect sensor. For example, the detected positions of the poles of the motor 104 are used to determine the speed of the motor 104.

In an embodiment, the sensor 108 comprises more than one Hall effect sensors. For example, the sensor 108 comprises a single Hall effect sensor, two Hall effect sensors, three Hall effect sensors, or the like. In another embodiment, the sensor 108 comprises any other type of sensor (e.g., other than the Hall effect sensor) to detect the position and/or the speed of the motor 104.

A back electromotive force (BEMF, also referred to as a counter-electromotive force) is a voltage, or an electromotive force, that acts against a current which induces the BEMF. BEMF is caused by a changing electromagnetic field. BEMF is an effect of Lenz's Law of electromagnetism. BEMF is a voltage that occurs, for example, in electric motors, where there is relative motion between an armature of the motor and an external magnetic field. In a motor using a rotating armature, conductors in the armature cut the magnetic field lines as the armature rotate. The varying magnetic field strength generates a voltage in the coil of the motor (e.g., based on Faraday's law of induction). This voltage opposes the original applied voltage in the motor, and hence, the voltage is also termed as a back electromotive force or a counter-electromotive force.

The system 100 further comprises a BEMF detection module 112. The BEMF detection module 112 is configured to detect a BEMF produced while the motor 104 is being rotated. Based on the detected BEMF, the BEMF detection module 112 detects the position and/or the speed of the motor 104. An example of detecting the position and/or the speed of a motor based on BEMF is disclosed in co-pending U.S. patent application Ser. No. ______, filed ______ (Attorney Docket No. MP 4921), which is incorporated herein by reference.

Thus, the BEMF detection module 112 does not include a sensor that is disposed on the motor 104. Rather, the BEMF detection module 112 detects the speed and/or the position of the motor 104 by measuring a voltage induced in a wiring of the motor 104. Accordingly, the BEMF detection module 112 performs a sensor-less detection of the speed and/or the position of the motor 104 (i.e., performs the detection without using a sensor).

A BEMF can be detected by the BEMF detection module 112 while the motor 104 has attained sufficient speed (e.g., when the motor 104 rotates above a threshold speed). However, while the motor 104 is rotating at a low speed (e.g., during a start-up of the motor 104) or while the motor 104 is not rotating, the BEMF detection module 112 cannot detect sufficient BEMF, and hence, cannot detect a speed of the motor 104.

During a soft start of the motor 104, the motor soft start module 116 regulates the voltage applied to the motor 104 while the motor 104 is being gradually started, and the speed of the motor 104 is gradually increased from zero to an intended speed. A soft start of the motor 104, for example, ensures low noise during the start-up of the motor 104, reduces the mechanical stress on the motor 104, and reduces electrodynamic stresses on power cables attached to the motor 104, thereby extending a lifespan of the system 100. In an example, the motor soft start module 116 comprises solid state devices to control the current flow and the voltage applied to the motor 104 during the soft starting of the motor 104. In an embodiment, to facilitate a soft start of the motor 104, the motor soft start module 116 requires feedback information about the speed and/or the position of the motor 104.

Subsequent to the soft start of the motor 104 (i.e., while the motor is operating at a sufficiently high speed), the speed control module 120 regulates the voltage applied to the motor 104, to regulate a speed of the motor 104. For example, the speed control module 120 regulates the voltage applied to the motor 104 while the motor 104 is operating at or near a nominal speed (e.g., an intended speed) of the motor 104. In an embodiment, to facilitate speed control, the speed control module 120 also requires feedback information about the speed and/or the position of the motor 104.

As previously discussed, while the motor 104 is rotating at a low speed (e.g., during a start-up of the motor 104) or while the motor 104 is not rotating, the BEMF detection module 112 cannot detect sufficient BEMF, and hence, cannot detect the position and/or the speed of the motor 104. Accordingly, while the motor 104 is rotating below a threshold speed (or is at stand-still), the sensor 108 is used to detect the speed and/or the position of the motor 104. Once the motor 104 has achieved at least the threshold speed, the BEMF detection module 112 is used to detect the speed and/or the position of the motor 104. In an embodiment, once the motor 104 has achieved at least the threshold speed, both the BEMF detection module 112 and the sensor 108 are used to detect the speed and/or the position of the motor 104. In an embodiment, the threshold speed is based on, for example, a sensitivity of the BEMF detection module 112. As an example, the threshold speed is based on a minimum speed of the motor 104, which may be relatively accurately detected by the BEMF detection module 112 (e.g., based on detecting the BEMF generated at the minimum speed). For example, the threshold speed can be slightly higher than the minimum speed.

Put differently, the sensor 108 is used detect the speed and/or the position of the motor 104 during the start up of the motor 105. For example, the motor soft start module 116 uses the output of the sensor 108 to perform a soft start of the motor 104. Once the motor 104 has achieved at least the threshold speed, the BEMF detection module 112 is used to detect the speed and/or the position of the motor 104 (e.g., instead of, or in addition to the detection of the speed and/or the position of the motor 104 by the sensor 108). For example, once the motor 104 has achieved at least the threshold speed, the speed control module 120 uses the output of the BEMF detection module 112 (e.g., instead of, or in addition to the output of the sensor 108) to control the speed of the motor 104.

A rotor lock event refers to stopping of the motor 104, while the motor 104 is supposed to rotate, e.g., due to a fault or a failure of the motor 104. In an embodiment, the sensor 108 and/or the BEMF detection module 112 can be used to detect such a rotor lock event. For example, the sensor 108 can detect the rotor lock event based on actually monitoring the speed of the motor 105. The BEMF detection module 112 can detect the rotor lock event based on a sudden absence of detection of BEMF, while the speed control module 120 is supplying sufficient power to drive the motor 104 at the regular speed of the motor 104.

Selectively using the sensor 108 and the BEMF detection module 112 to detect the speed and/or the position of the motor 104 has several advantages. For example, using the sensor 108 facilitates soft start of the motor 104. Once the motor 104 has attained sufficient speed, the BEMF detection module 112 is used to relatively accurately detect the speed and/or the position of the motor 104.

For a conventional motor that only employs Hall effect sensors to detect a speed and/or a position of the motor, a large number of Hall effect sensors may be needed for accurate detection. For example, for a three phase conventional motor, three or more Hall effect sensors may be used to detect a speed and/or a position of the conventional motor. However, in the system 100, since the sensor 108 (which comprises one or more Hall effect sensors) is primarily used during the start up of the motor 104 (and the BEMF detection module 112 is used during a regular operation of the motor 104), a relatively lower number of Hall effect sensors may be needed. For example, for a three phase motor 104 of the system 100, one or two Hall effect sensors may be used, in addition to using the BEMF detection module 112, to detect the speed and/or the position of the motor 104. That is, compared to a conventional motor that employs a large number of Hall effect sensors to detect a speed and/or a position of the motor, the sensor 108 of the system 100 comprises a relatively lower number (e.g., one, two, or the like) of Hall effect sensors. The reduction of the number of Hall effect sensors in the system 100 does not compromise on an accuracy of the detection of the speed and/or position of the motor 104, as the BEMF detection module 112 is used during a regular operation of the motor 104 for relatively accurate detection of the speed and/or the position of the motor 104. The reduction in the number of Hall effect sensors in the system 100 (e.g., compared to a conventional system employing only Hall effect sensors) results in, for example, reduced manufacturing cost, reduced complexity in placing and routing the Hall effect sensors, the accompanying ICs and the wires.

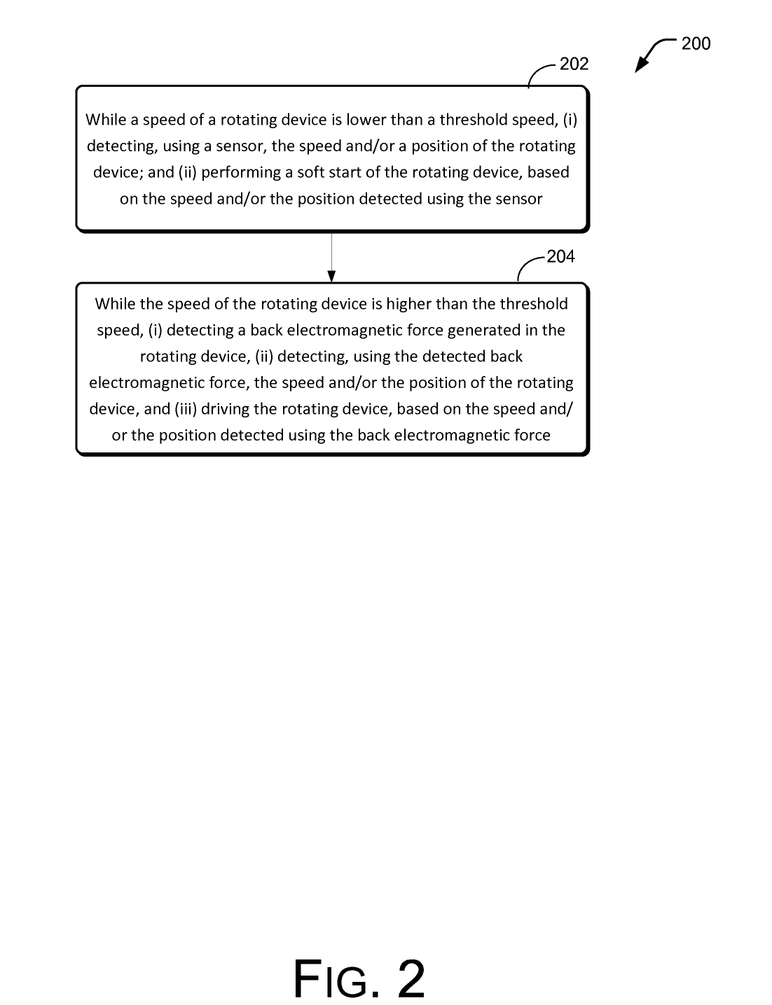

FIG. 2 illustrates an example method 200 for detecting a position and/or a speed of a rotating device (e.g., the motor 104 of FIG. 1), and driving the rotating device. At 204, while a speed of the rotating device is lower than a threshold speed, a sensor (e.g., the sensor 108) is used to detect the speed and/or a position of the rotating device. Furthermore, a soft start of the rotating device is performed (e.g., by the motor soft start module 116), based on the speed and/or the position detected using the sensor. In an embodiment, the sensor comprises one or more Hall effect sensors.

At 208, while the speed of the rotating device is higher than the threshold speed (e.g., subsequent to the soft start of the rotating device and once the rotating device has attained sufficient speed), a back electromagnetic force generated in the rotating device is detected (e.g., by the BEMF detection module 112), and using the detected back electromagnetic force, the speed and/or the position of the rotating device is detected (e.g., by the BEMF detection module 112). Furthermore, the rotating device is driven (e.g., by the speed control module 120), based on the speed and/or the position detected using the back electromagnetic force. In an embodiment, the back electromagnetic force is detected in a wiring of the rotating device.

In accordance with various embodiments, an article of manufacture may be provided that includes a storage medium having instructions stored thereon that, if executed, result in the operations described herein with respect to the method 200 of FIG. 2 (and/or various other operations discussed in the present disclosure). In an embodiment, the storage medium comprises some type of non-transitory memory. In accordance with various embodiments, the article of manufacture may be a computer-readable medium such as, for example, software or firmware.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

The description incorporates use of the phrases “in an embodiment,” or “in various embodiments,” which may each refer to one or more of the same or different embodiments. Furthermore, the terms “comprising,” “including,” “having,” and the like, as used with respect to embodiments of the present disclosure, are synonymous.

Various operations may have been described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

Although specific embodiments have been illustrated and described herein, it is noted that a wide variety of alternate and/or equivalent implementations may be substituted for the specific embodiment shown and described without departing from the scope of the present disclosure. The present disclosure covers all methods, apparatus, and articles of manufacture fairly falling within the scope of the appended claims either literally or under the doctrine of equivalents. This application is intended to cover any adaptations or variations of the embodiment disclosed herein. Therefore, it is manifested and intended that the present disclosure be limited only by the claims and the equivalents thereof.

What is claimed is:

1. A method comprising:
detecting, based on a sensor and a back electromagnetic force generated in a rotating device, a speed of the rotating device; and
based on (i) the speed detected using the sensor or (ii) the speed detected using the back electromagnetic force, driving the rotating device.

2. The method of claim 1, wherein detecting the speed of the rotating device further comprises:
during a start-up of the rotating device, detecting, based on the sensor, the speed of the rotating device; and
subsequent to the start-up of the rotating device and while the speed of the rotating device is higher than a threshold speed,
detecting the back electromagnetic force generated in the rotating device, and
detecting, based on the detected back electromagnetic force generated in the rotating device, the speed of the rotating device.

3. The method of claim 1, wherein detecting the speed of the rotating device further comprises:
while the speed of the rotating device is lower than a threshold speed, detecting, based on the sensor, the speed of the rotating device; and
while the speed of the rotating device is higher than the threshold speed,
detecting the back electromagnetic force generated in the rotating device, and
detecting, based on the detected back electromagnetic force generated in the rotating device, the speed of the rotating device.

4. The method of claim 3, further comprising:
while the speed of the rotating device is lower than the threshold speed, refraining from detecting the speed of the rotating device using the back electromagnetic force.

5. The method of claim 3, wherein detecting the speed of the rotating device while the speed of the rotating device is higher than the threshold speed further comprises:
while the speed of the rotating device is higher than the threshold speed, detecting, using (i) the detected back electromagnetic force and (ii) the sensor, the speed of the rotating device.

6. The method of claim 1, wherein driving the rotating device further comprises:
based on the speed detected using the sensor, performing a soft start of the rotating device by regulating a voltage applied to the rotating device during a start-up of the rotating device.

7. The method of claim 1, wherein driving the rotating device further comprises:
based on the speed detected using the back electromagnetic force, driving the rotating device while the speed of the rotating device is higher than a threshold speed.

8. The method of claim 1, further comprising:
while the speed of the rotating device is lower than a threshold speed, monitoring, using the sensor, a position of the rotating device, wherein monitoring the position of the rotating device comprises monitoring a position of at least one of a pole and a rotor of the rotating device; and
while the speed of the rotating device is higher than the threshold speed, monitoring, using the detected back electromagnetic force, the position of the rotating device,
wherein driving the rotating device further comprises
based on (i) the position detected using the sensor or (ii) the position detected using the back electromagnetic force, driving the rotating device.

9. The method of claim 1, wherein the back electromagnetic force is generated in a winding of the rotating device, based on the rotation of the rotating device.

10. The method of claim 1, further comprising:
detecting an absence of back electromagnetic force generated in the rotating device; and
based on detecting the absence of back electromagnetic force generated in the rotating device, detecting a rotor lock event in the rotating device.

11. The method of claim 1, wherein the sensor comprises one or more Hall effect sensors.

12. A system comprising:
a rotating device;
a sensor configured to detect the speed of the rotating device; and
a back electromagnetic force (BEMF) module configured to
detect a back electromagnetic force generated in the rotating device, and
detect, using the detected back electromagnetic force, the speed of the rotating device,
wherein the rotating device is driven based on the speed detected using (i) the output of the sensor or (ii) the speed detected using the back electromagnetic force.

13. The system of claim 12, wherein:
wherein while the speed of the rotating device is lower than a threshold speed, an output of the sensor is used to detect the speed of the rotating device; and
while the speed of the rotating device is higher than the threshold speed, the BEMF is module configured to
detect the back electromagnetic force generated in the rotating device, and
detect, using the detected back electromagnetic force, the speed of the rotating device,

14. The system of claim 12, further comprising:
a soft start module configured to, based on the speed detected using the output of the sensor, perform a soft start of the rotating device by regulating a voltage applied to the rotating device during a start-up of the rotating device.

15. The system of claim 12, further comprising:
a speed control module configured to drive the rotating device, while the speed of the rotating device is higher than a threshold speed, based on the speed detected using the back electromagnetic force.

16. The system of claim 12, wherein:
while the speed of the rotating device is lower than a threshold speed, an output of the sensor is used to monitor a position of the rotating device;
the position of the rotating device comprises a position of at least one of (i) a pole of the rotating device and (ii) a rotor of the rotating device;
while the speed of the rotating device is higher than a threshold speed, the detected back electromagnetic force is used to monitor the position of the rotating device; and
the rotating device is driven based on the position detected using (i) the output of the sensor and (ii) the position detected using the back electromagnetic force.

17. The system of claim 12, wherein the BEMF module is further configured to, while the speed of the rotating device is lower than a threshold speed, refrain from detecting the speed of the rotating device using the back electromagnetic force.

18. The system of claim 17, wherein the threshold speed is based on a minimum speed at which sufficient back electromagnetic force is generated in order to enable the BEMF module to detect the speed of the rotating device based on the generated back electromagnetic force.

19. The system of claim 12, wherein the BEMF module is further configured to:
detect an absence of back electromagnetic force generated in the rotating device; and
based on detecting the absence of back electromagnetic force generated in the rotating device, detect a rotor lock event in the rotating device.

20. The system of claim 12, wherein the sensor comprises one or more Hall effect sensors.
